(19) United States
(12) Patent Application Publication
(10) Pub. No.: US 2019/0086075 A1
(43) Pub. Date: Mar. 21, 2019

(54) STEAM GENERATOR FOR A STEAM COOKING APPLIANCE, STEAM COOKING APPLIANCE HAVING A STEAM GENERATOR OF SAID TYPE, AND METHOD FOR GENERATING STEAM

(71) Applicant: E.G.O. Elektro-Geraetebau GmbH, Oberderdingen (DE)

(72) Inventor: Tobias Albert, Kraichtal (DE)

(21) Appl. No.: 16/128,634

(22) Filed: Sep. 12, 2018

(30) Foreign Application Priority Data
Sep. 19, 2017 (DE) 10 2017 216 599.5

(51) Int. Cl. F22B 1/28; A47J 27/04; B01D 45/16; A23L 5/10

(52) U.S. Cl. CPC F22B 1/284; A47J 27/04; A23V 2002/00; A23L 5/13; A47J 2027/043; B01D 45/16

(57) ABSTRACT

A steam generator for a steam cooking appliance having a cooking chamber has steam-generating means, a water supply to the steam-generating means, a cyclone separator for steam generated by the steam-generating means, and a steam outlet from the cyclone separator to the cooking chamber of the steam cooking appliance. The cyclone separator forms an integrated structural unit with the steam-generating means, with a direct entry of steam from the steam-generating means into the cyclone separator and with a direct exit of separated-off water from it into the steam-generating means. The integrated structural unit yields advantages in the production and assembly of the steam generator and installation of the steam cooking appliance as a whole.

### CROSS-REFERENCE TO RELATED APPLICATIONS

This application claims priority from German Application No. 10 2017 216 599.5, filed Sep. 19, 2017, the contents of which are hereby incorporated herein in its entirety by reference.

### BACKGROUND

The invention relates to a steam generator for a steam cooking appliance, to a steam cooking appliance of said type having a corresponding steam generator, and to a method for generating steam by means of a steam generator.

Normally, steam from a steam generator is introduced into a cooking chamber of a steam cooking appliance in order to cook items for cooking in a known manner by means of steam there. A common problem here is that small water droplets are often contained in the steam produced by boiling water, which is undesirable. Therefore, in DE 10 2012 200 289 A1, a steam cooking appliance is equipped with a steam generator which is arranged outside a cooking chamber of the appliance. Between the steam generator and cooking chamber, there is arranged a so-called cyclone separator. Said cyclone separator permits an effective separation of water from the water steam introduced from the steam generator. In this way, it is possible to achieve considerably improved cooking results for the foodstuff, and disruptive water deposits in the cooking chamber are avoided. The cyclone separator has a cyclone channel which narrows in spiral fashion, wherein, as a result of the introduced water steam being swirled around in circulating fashion, the water droplets are centrifuged out of the steam in an outward direction, such that they can be separated.

### BRIEF SUMMARY

The invention is based on the object of providing a steam generator as mentioned in the introduction, a steam cooking appliance having a steam generator of said type, and a method for generating steam, by means of which problems of the prior art can be resolved, and it is in particular possible to construct an advantageous steam generator and install this into a steam cooking appliance in an effective manner.

Said object is achieved by means of a steam generator having the features of claim 1, a steam cooking appliance having a steam generator of said type having the features of claim 25, and a method for generating steam, having the features of claim 26. Advantageous and preferred refinements of the invention are the subject matter of the further claims, and will be discussed in more detail below. Here, some of the features are described only for the steam generator, only for the steam cooking appliance or only for the method for generating steam. They are however intended to be applicable, independently of this, both to the steam generator and to the steam cooking appliance and to the method for generating steam independently of one another. The wording of the claims is incorporated into the content of the description by express reference.

Provision is made for the steam generator for a steam cooking appliance, which in the conventional manner has a cooking chamber, to have steam-generating means and a water supply to the steam-generating means. Furthermore, a cyclone separator is provided for treating the steam generated by the steam-generating means, or for separating off water droplets to the greatest possible extent. Finally, a steam outlet leads away from the cyclone separator of the steam generator in order to run to a cooking chamber of the steam cooking appliance.

According to the invention, provision is made whereby the cyclone separator forms an integrated structural unit with the steam-generating means, such that steam from the steam-generating means directly enters the cyclone separator. It is advantageously additionally possible to provide for water that has been separated from the cyclone separator to directly exit said cyclone separator back into the steam-generating means, preferably by just a short pipe or a channel. In particular, it may be provided that the water is brought back into the steam-generating means without a pump. Firstly, it is the intention for the water to be removed from the cyclone separator, at least after a short operating period. Secondly, said water can specifically be reused in an effective manner for renewed evaporation. In this way, not only is it possible for water to be saved, but a discharge of excess water can be saved.

With the invention, it is possible to save structural space in the steam cooking appliance in relation to the abovementioned prior art. Furthermore, further system prefabrication is possible by virtue of the fact that it is specifically only necessary for the structural unit composed of steam-generating means and cyclone separator, and no longer two separate functional units with multiple lines or pipes or hoses in between, to be installed into the steam cooking appliance. Through the integration of steam-generating means and cyclone separator into the structural unit, the path for the steam to the water separation can also be shortened, whereby the steam remains hot for longer, which is highly advantageous for the use in the cooking chamber. If provision is made for separated-off water to directly exit the cyclone separator back into the steam-generating means, this is also possible considerably more easily owing to the functional integration, because a second line is not required. A further major advantage of the invention is the reduction of sealing points or the greater robustness and improved sealing action, owing to the integration into a structural unit, in relation to two initially separate functional units which are then connected to one another, the sealing action of which is more vulnerable during an installation process. By means of the integration, it is also possible to realize a relatively small structural size of the integrated structural unit, the space saving of which is considerably more pronounced than that which results from the mere omission of the steam feed line and water return line required in the prior art.

In one refinement of the invention, the cyclone separator may advantageously be mounted onto the steam-generating means. Here, the cyclone separator is particularly advantageously mounted directly above the steam-generating means, that is to say above the latter in a vertical direction. This corresponds to an optimum direction of movement of generated steam from the steam-generating means into the cyclone separator. Furthermore, in this way, it is also possible for separated-off water to pass from the cyclone separator back into the steam-generating means in the most effective possible manner.

In one refinement of the invention, the steam-generating means and the cyclone separator may be formed as a structural unit such that they have a common external housing. Said common external housing has the advantage that the structural unit is easier to handle, in particular during the installation of the steam cooking appliance, and has no mechanically sensitive points. A common external housing may also provide joint mechanical strength for the steam generator. Here, it is possible for the external housing to be divided in two, that is to say to be composed, so to speak, of two housing parts. In particular, said external housing may have an upper housing part and a lower housing part. These should advantageously be of equal size or equal diameter and/or have an identical cross section, such that they can be mounted one to the other in a relatively seamless or transition-free manner in order to form the finished external housing. The two housing parts may be designed such that they can be detachably assembled, or may be non-detachably connected, for example by adhesive bonding or welding.

In a further possible refinement of the invention, provision may be made for the lower housing part to comprise the steam generator, advantageously self-evidently the single steam generator. The upper housing part may correspondingly have a cyclone separator, or particularly advantageously the single cyclone separator. Said housing parts can thus also have or form functional tasks of the two functional units steam generator and cyclone separator. Furthermore, the two housing parts may also be composed of different materials, such that they are adapted in a functionally optimal manner.

In an advantageous refinement of the invention, the steam-generating means have a tubular part or housing which forms a steam-generating chamber. The tubular housing is particularly advantageously round or even circular. It can thus be easily produced, and there are no corners or edges which are difficult to access for cleaning or in which dirt can take particularly firm hold. A tubular housing of said type should advantageously be arranged upright in the steam generator, or have a vertical central longitudinal axis. A steam-generating chamber formed in this way particularly advantageously has an externally situated heating means, which is not at risk of accumulating limescale, and therefore it is also the case that no electrically conductive parts or regions are situated within the steam-generating chamber and thus potentially within the water. Such an externally situated heating means is known for example from heated water pumps or from other steam generators, see for example WO 2008/151798 A2.

A tubular housing of said type may advantageously be composed of metal, such that said heating means can be applied to the outer side thereof in a very effective manner, for example with thick-film heating elements known from the prior art. Said housing may under some circumstances also be an abovementioned lower housing part of the common external housing, as has been discussed above. Alternatively, the externally situated heating means may also once again be covered by a cover in order to protect against damage and for the purposes of electrical insulation. Such a cover may then optionally also form a part of an abovementioned external housing, for example specifically with the cyclone separator as an upper region or housing part of the external housing. In all cases, it is however significant that the cyclone separator and the steam-generating means or the steam-generating chamber are sealingly connected to one another such that, firstly, no steam escapes and is lost, and secondly, there is no risk of electrical insulation problems.

In the case of the steam-generating chamber, provision may be made for it to have a chamber base. Furthermore, it has a water inlet and a water outlet, wherein, in particular, the water inlet is advantageously designed and arranged such that it does not disrupt the rising steam generated by the steam-generating means. Furthermore, it should be possible for water to be replenished, under some circumstances even continuously, for the most effective possible operation of the steam generator. At least one water outlet should be situated at the lowest point of the chamber base, for which purpose said chamber base is advantageously inclined downward, or at least runs downward to the water outlet. The water inlet and water outlet may also be provided with a single opening into the steam-generating chamber, which opening is then, by means of a corresponding configuration of lines outside the steam-generating chamber, either flowed through by inflowing water as a water feed, or out of which opening water that still remains after operation of the steam generator, when further steam is no longer required, can be discharged again. The fewer openings are provided into the steam-generating chamber, the less sealing is required, and the less scope there is for problems to occur. A water outlet or an abovementioned single opening may advantageously be provided approximately centrally in the chamber base, which is advantageously deepened toward the centre. The steam-generating chamber is preferably formed as a pipe section with a circular cross section and with ends cut off in a straight manner. Said steam-generating chamber can thus be produced and sealed, and installed into the structural unit of the steam generator, in the most effective possible manner.

Thus, whereas the steam-generating means may advantageously be composed of metal or may have at least one tubular housing composed of metal, the cyclone separator is advantageously composed of plastic. Said cyclone separator can thus be produced relatively easily and can be shaped in a wide variety of ways, in particular in order to realize the cyclone shape. For easier installation of the steam generator, the cyclone separator may be in one piece, wherein, for this purpose, it may particularly advantageously be assembled from at least two parts. For this purpose, said parts may be non-detachably connected to one another, for example by adhesive bonding. The production by means of plastics injection moulding is specifically also possible for highly complex parts, though is considerably less expensive if said parts are of less complex form and, instead, are multiple parts which can then be connected to one another.

A steam outlet from the cyclone separator is advantageously arranged centrally, wherein it runs upwards, particularly advantageously directly vertically upwards, in particular also in the installed state in a steam cooking appliance. Thus, the steam can optimally flow out from the cyclone separator of its own accord when water droplets have been separated. Such a steam outlet may in this case run along a central longitudinal axis of the cyclone separator and/or of the steam-generating means.

It is preferably possible for a cyclone separator to have a cyclone channel which runs at least in sections in arcuate fashion and in which water steam is separated into firstly as far as possible pure steam and secondly water or water droplets, such that water droplets are separated. The cyclone separator may have at least one water steam inlet for introducing water steam from the steam-generating means, arranged therebelow or thereon, into the cyclone separator or into the cyclone channel. Said water steam inlet advantageously has a relatively large area in relation to the cross section of the abovementioned steam outlet. Said steam outlet in turn is provided at the end region of the cyclone channel. A water outlet from the cyclone separator or from the cyclone channel is provided for discharging water, which has been separated off from the water steam, again, preferably after said water has been collected. The water is advantageously conducted downwards into the steam-generating chamber of the steam-generating means, or runs into said steam-generating chamber of its own accord. The cyclone channel may have a cross-sectional reduction at a starting region situated close to the water steam inlet. Thus, a flow of water steam, specifically also shortly downstream of the point at which it enters the cyclone channel, can be improved; for example, it is possible here for a first separation of water droplets to be performed, which can then fall or flow directly downwards into the steam-generating means or the steam-generating chamber thereof.

The cyclone channel advantageously has a cyclone base which may run, in a radially outer region of the cyclone channel, in a plane. Said radially outer region is for example outside 50% of the radius of the cyclone separator. Here, under some circumstances, provision may be made for a cyclone side wall, which advantageously lies on the cyclone base, to run in spiral fashion and, in so doing, to narrow. Such a narrowing is advantageously continuous, wherein it need not imperatively be uniform. By means of such a narrowing, the water steam flowing along can be once again slightly compressed and/or accelerated, wherein, owing to the circulation in spiral fashion, small water droplets can be centrifuged out or separated off and can collect on the cyclone base.

In a radially inner region of the cyclone separator and/or at the end of the cyclone channel, there is advantageously provided a channel depression which extends below the plane of the cyclone base in the radially outer region of the cyclone channel. The height of the channel depression may, for example, amount to more than two times the height of the cyclone channel in the radially outer region, wherein the channel depression advantageously runs only downwards or below the plane of the cyclone base. In an upward direction, the same delimiting plane may be provided as for a radially outer region of the cyclone channel. Water that has been separated from the water steam can collect in said channel depression and flow, or be discharged, downwards back into the steam-generating means. The channel depression may be designed so as to have a step, or to be of non-continuous design. Thus, a better outflow of water can be achieved. The channel depression may advantageously be of round or even circular design.

In one advantageous refinement of the invention, the channel depression is at least partially conical or at least partially has a funnel shape, for example as a funnel with a straight upper edge. It may be arranged around a central axis of the cyclone separator, preferably radially symmetrically about a central axis of said type.

The abovementioned water outlet may proceed downwards from a lowest point of the channel depression. In particular, said water outlet is central with respect to the central axis of the channel depression or of the cyclone separator. The water can flow off in a particularly effective manner from said lowest point. A water outlet may have the form of a short pipe or a short line. The water outlet can and should lie below a plane in which an upper edge of the heating means of the steam-generating means is situated. It can thus be achieved that, in the steam-generating means or in the steam-generating chamber, the water level always lies approximately at the upper edge of the heating means, such that the latter is protected against overheating, and the water within the steam-generating chamber always absorbs sufficient heat from the heating means. Thus, a water level should always extend as far as here, and the water outlet of the cyclone separator thus ends in the water. Thus, here, no steam can escape from the steam-generating means, which would be disruptive.

The channel depression may also have the important task of at least partially, preferably entirely, forming a separation region in which water is separated off from the water steam. For this purpose, provision may also be made for a steam outlet to have a downwardly projecting steam outlet pipe. The lower pipe opening thereof is situated in the region of the channel depression and advantageously runs below the plane of the cyclone base in the radially outer region of the cyclone channel. Steam then cannot so easily escape from the separation region, but rather must, so to speak, enter from below. In this way, the separation of water droplets from the water steam is further intensified or improved. Provision may be made for the steam outlet pipe and the water outlet to be aligned with one another or to run along a common straight line.

From the steam-generating means, steam can rise directly upwards from the boiling water and enter the cyclone separator, advantageously through a water steam inlet. For this purpose, it is optionally also possible for two separate and mutually spaced-apart water steam inlets to be provided. The steam can thus directly enter the cyclone channel. Through the provision of two water steam inlets, which are advantageously situated opposite one another relative to a central axis of the cyclone separator, a greater amount of water steam can enter the cyclone channel. The two water steam inlets may advantageously lead into one and the same cyclone channel, such that an altogether larger entry cross section for water steam into the cyclone separator is easily realized. By means of the two possible ways for water steam to enter the cyclone channel, the circulation of the water steam in the cyclone separator can possibly be improved. Alternatively, one single, large water steam inlet may be provided, which may extend with an elongate form around at least one half of a circumference.

A steam cooking appliance according to the invention has at least one above-described steam generator. The steam generator is arranged within a housing of the steam cooking appliance. To supply water, a water inlet into the steam-generating means is provided, said water inlet advantageously being equipped with a pump for the desired replenishment of water. Steam is conducted from the steam outlet of the cyclone separator into a cooking chamber of the steam cooking appliance, wherein this may take place as is known per se from the prior art. Preferably, the steam is admitted into the cooking chamber at a side or a rear wall. It is duly basically possible for a steam generator to also be arranged in the lower region of the steam cooking appliance, or possibly even below the cooking chamber. Then, however, the introduction of steam and the distribution in the cooking chamber are possibly made more difficult.

To now generate steam according to the invention for a cooking chamber of a steam cooking appliance, water is firstly heated in order to generate water steam. For this purpose, the water may advantageously be caused to simmer or even brought to a rolling boil. Directly above the heated water, water steam that is produced is transferred or introduced into a cyclone separator with cyclone channel. There, the water steam is, within the cyclone channel, conducted in circulating fashion spirally inwards in accordance with the profile of the cyclone channel. Here, water is separated off or centrifuged out of the water steam in the form of small water droplets. Said water is collected, advantageously on a cyclone base of the cyclone channel, and is recirculated into the steam-generating means again. The steam that has had the water droplets removed therefrom is discharged from the cyclone separator in order to enter the cooking chamber of the steam cooking appliance. By means of the heat energy introduced at the heating means of the steam-generating means, the amount of steam generated can be set. Accordingly, a generation of steam can be achieved continuously or else at intervals.

These and further features will emerge not only from the claims but also from the description and from the drawings, wherein the individual features may be realized in each case individually or severally in the form of sub-combinations in an embodiment of the invention and in other fields, and may constitute advantageous and independently protectable embodiments for which protection is claimed here. The division of the application into individual sub-sections and sub-headings do not restrict the statements made here in terms of their general applicability.

### BRIEF DESCRIPTION OF THE DRAWINGS

Exemplary embodiments of the invention are schematically illustrated in the drawings and will be discussed in more detail below. In the drawings:

FIG. 1 shows a schematic construction of a steam cooking appliance according to the invention with a steam generator according to the invention for a cooking chamber,

FIG. 2 shows the steam generator on its own in a vertical section,

FIG. 3 shows the steam generator, with the upper cover having been cut away, in an oblique view, and

FIG. 4 shows the steam generator from FIG. 3 in the direct plan view.

### DETAILED DESCRIPTION

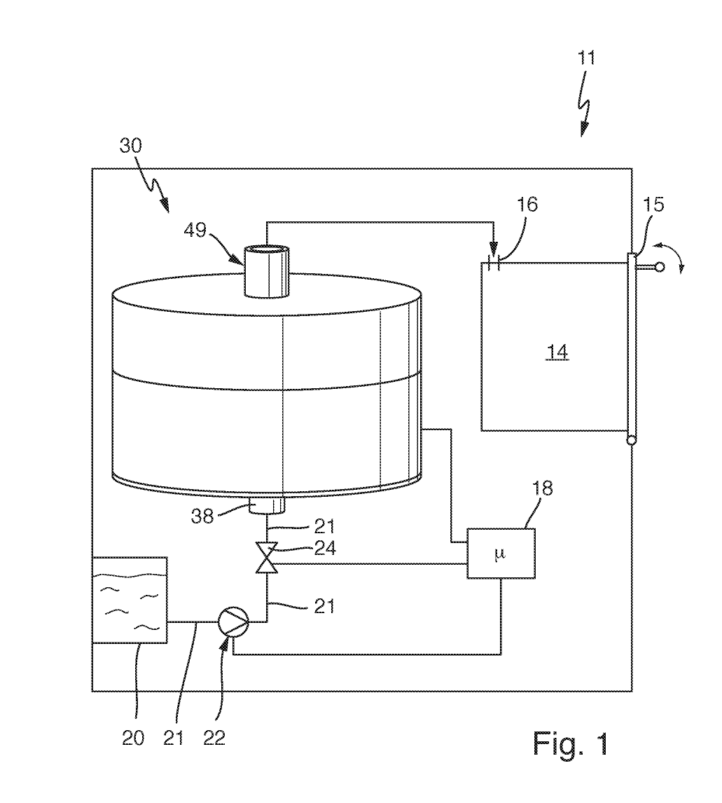

FIG. 1 shows a highly simplified illustration of a steam cooking appliance 11 according to the invention with the parts essential to the invention. The steam cooking appliance 11 has a housing 12 with a cooking chamber 14 which is accessible from the right via a door 15. A steam inlet 16 leads into the cooking chamber 14 from above. The steam inlet 16 leads to a steam generator 30 which will be discussed in more detail below. A water outlet from said cooking chamber is possible, but is not relevant here.

The steam cooking appliance 11 has a controller 18 which controls the operation of the steam generator 30 with regard to both heating and a supply of water. A water tank 20 is connected by means of water lines 21 to the steam generator 30. For a controlled supply of water and a controlled discharge of water, a pump 22 and a valve 24 are provided in the water lines 21, which pump and valve are connected to the controller 18, in a similar manner to a heating means (not illustrated in any more detail here) of the steam generator 30. The pump 22 can pump water from the water tank 20 into the steam generator 30 in a manner controlled by the controller 18, for which purpose the valve 24 is opened. During the evaporation, the valve 24 may remain at least partially closed and be opened only for the replenishment of water. After a generation of steam, or after the end of the operation of the steam cooking appliance 11, the valve 24 can be opened by the controller 18 such that remaining water either flows back from the steam generator 30 into the water tank 20 of its own accord, or is pumped back with assistance from the pump 22 if the pump 22 is designed correspondingly.

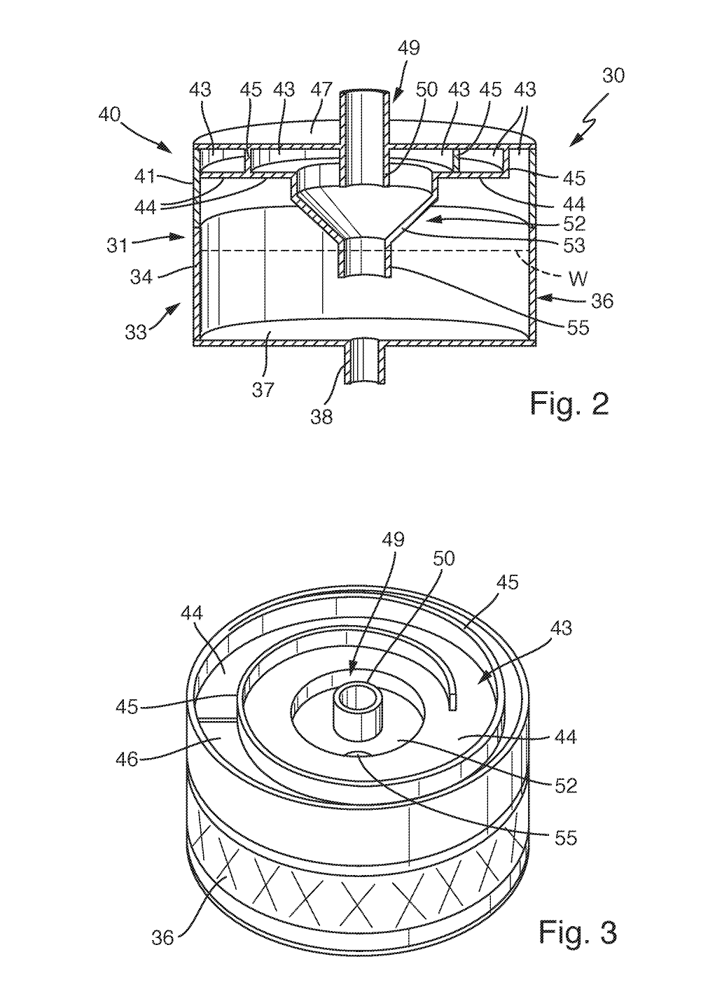

FIGS. 2 to 4 illustrate the steam generator 30 according to the invention in more detail. As shown in FIG. 3, a heating element 36 is applied to the outside in the lower region. Said lower region of the steam generator 30 is situated at an outer side of its housing 31 and is thus part of the abovementioned steam-generating means with a lower housing part 34. In the steam-generating means 33, water is heated by the heating means 36 and is caused to simmer or brought to a boil, such that water steam is generated. Water can be fed, or else discharged, via a water inlet 38 in the base 37 of the steam-generating means 33. Illustrated by dashed lines, with the designation “W”, is a water level line for normal operation of the steam generator 30, such that the steam-generating means 33 are filled up to approximately said water level line W. For this purpose, use may be made for example of water level sensors of a wide variety of types, which will not be discussed in any more detail here. This may be realized by means of conductivity sensors, capacitive sensors or else temperature sensors on the outer side of the steam-generating means 33. A person skilled in the art can correspondingly find these in the prior art and apply or install them here.

A cyclone separator 40 is mounted, specifically directly mounted, onto the steam-generating means 33. An outer wall of an upper housing part 41 of the cyclone separator 40 can thus form a direct continuation of the form and cross section of the lower housing part 34. The two housing parts 34 and 41 can thus form an outer housing, as has been discussed in the introduction. This continuation of the contour need not be imperative, but is expedient for good steam guidance within the steam generator 30 and in particular for ensuring a sealing action between the two housing parts. Provision may also be made for an additional cover to be provided over the lower housing part 34 for the purposes of protecting the heating element 36, for example also in order to cover connector plugs or the like.

A connection of the lower housing part 34 and upper housing part 41 may be realized in a variety of ways. Firstly, this may be realized by adhesive bonding, wherein the lower housing part 34 generally has a shell composed of metal, and a base 37 is possibly composed of plastic. The upper housing part 41 is generally produced from plastic, simply owing to the better mouldability or producibility. The two housing parts 34 and 41 may also be assembled with a seal in between, while for example still being held together by means of clamping parts or the like.

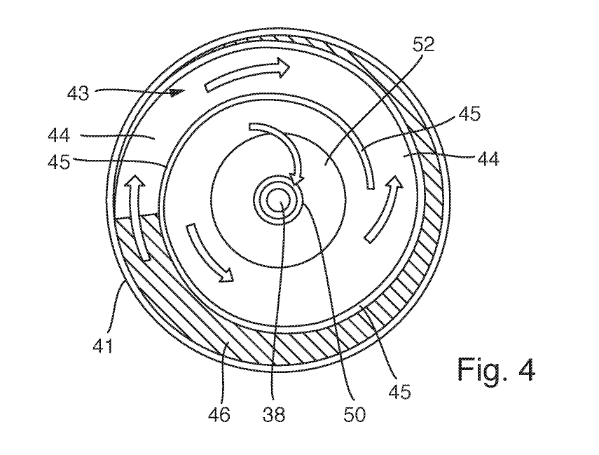

The cyclone separator 40 with the upper housing part 41 has a cyclone channel 43 that can be seen from FIGS. 2 to 4. Said cyclone channel runs clockwise as viewed from above and is formed between a cyclone base 44, parallel to and spaced apart from which there runs a cover 47. In between, there runs a cyclone partition 45 with the spiral form. It can be seen, in particular from FIG. 4 with the hatching, that a water steam inlet 46 is formed by, as it were, omitting the cyclone base 44, specifically over almost an entire circumference. Accordingly, the water steam inlet 46 has a varying width, or increasing in the flow direction. The cyclone channel 43 that adjoins said water steam inlet extends approximately over one and a half times the circumference, beginning where the water steam inlet 46 ends and the cyclone base 44 begins. The water steam inlet 46 as per the plan view in FIG. 4 could also be divided in two, for example by means of a web parallel to the cyclone base 44 toward the outer wall. Improved strength could be achieved in this way.

At the top in the cover 47, there is provided a steam outlet 49, which is then led to the steam inlet 16 into the cooking chamber 14 correspondingly to FIG. 1. At the steam outlet 49, there is provided a steam outlet pipe 50, which not only projects upward beyond the cover 47 but also projects downwards. FIG. 2 clearly shows that the steam outlet pipe 50 extends a considerable distance below the plane of the cyclone base 44. This means that water steam that enters and circulates in the cyclone channel 43 cannot escape from the steam generator 30 directly, so to speak, in a lateral direction and upwards through the steam outlet 49. Rather, the water steam must first be conducted downwards to a certain extent in order to then enter the steam outlet pipe 50 from below.

In this region at the bottom, a channel depression 52 is provided in the cyclone base 44. Said channel depression is, as shown in the plan view of FIG. 4, of circular symmetrical and substantially funnel-shaped form with a straight edge at the top and with a water outlet 55 which adjoins the funnel section 53 in a downward direction, and which in this case is in the form of a short pipe. Said water outlet 55 extends below the water level line W, at least during the normal operation of the steam generator 30. Thus, water steam is prevented from being able to rise directly upwards and emerge from the steam generator 30 through the steam outlet 49. The short water outlet 55 is sufficient in this case, a pump or the like for recycling the water into the steam generator 30 is not necessary.

As indicated by the arrows of FIG. 4, and as is easily conceivable, during the boiling of water in the steam generator 30, water steam is produced at the bottom in the steam-generating means 33. Said water steam also contains small water droplets, which are entrained. The water steam passes through the water steam inlet 46 in the form of an elongate slot upwards into the cyclone separator 40 or into the cyclone channel 43, and circulates clockwise. Here, it is possible for some of the water droplets to already be centrifuged out of the steam in an outward direction, and to collect on the inner sides of the cyclone partition 45 and on the cyclone base 44, owing to the centrifugal force. By means of a possible slight inclination of the cyclone base 44, water can either flow back downward again through the water steam inlet 46, or else can flow to the channel depression 52 with the water outlet 55. In the channel depression 52, owing to the relatively small radius, the action of the centrifuging of the water droplets is considerably further intensified, as is known from cyclone separators and can also be understood by a person skilled in the art from DE 10 2012 200 289 A1 as cited in the introduction. While the, so to speak, dewatered steam then flows out to the steam outlet 49 through the steam outlet pipe 50, the water, in particular the water that has been separated off in the channel depression 52, flows back downward again into the steam-generating means 33. There are thus no problems or effort involved in the recirculation of said water, and furthermore, the water can be utilized again for evaporation. This is thus one of the advantages of the very compact steam generator, which is formed as an integral structural unit. The further advantage is that, by connection of the two housing parts 34 and 41 and thus of the steam-generating means 33 and of the cyclone separator 40, a permanently sealed connection can be produced, in particular a non-detachable connection. Thus, the steam generator 30 according to the invention requires relatively little space in the steam cooking appliance 11, is very easy to install, and is highly operationally reliable.

It is evidently expedient for the cyclone separator 40 to be produced from plastic by plastics injection moulding, such that a desired form can be achieved. Here, the cyclone separator 40 may be composed of two parts, such that, for example, the cover 47 together with the steam outlet pipe 50 is a first part, and the rest forms a second part. The outer shell may be integrally formed on said part, or else possibly on the part with the cyclone base 44.

That which is claimed:

1. Steam generator for a steam cooking appliance having a cooking chamber, having:
steam-generating means,
a water supply to said steam-generating means,
a cyclone separator for steam generated by said steam-generating means,
a steam outlet from said cyclone separator to said cooking chamber of said steam cooking appliance,
wherein:
said cyclone separator forms an integrated structural unit with said steam-generating means, with a direct entry of steam from said steam-generating means into said cyclone separator.

2. Steam generator according to claim 1, wherein a direct exit of separated-off water from said cyclone separator into said steam-generating means is provided without a pump.

3. Steam generator according to claim 1, wherein said cyclone separator is mounted onto the steam-generating means.

4. Steam generator according to claim 3, wherein said cyclone separator is arranged directly above said steam-generating means in a vertical direction.

5. Steam generator according to claim 1, wherein said steam-generating means and said cyclone separator have, as a structural unit, a common external housing.

6. Steam generator according to claim 5, wherein said external housing is divided at least in two with at least an upper housing part and a lower housing part.

7. Steam generator according to claim 6, wherein said lower housing part comprises said steam-generating means, and said upper housing part comprises said cyclone separator.

8. Steam generator according to claim 1, wherein said steam-generating means have a tubular housing which forms a steam-generating chamber.

9. Steam generator according to claim 5, wherein said steam-generating chamber has an externally situated heating means, and wherein said tubular housing of said steam-generating means is a lower housing part of said common external housing.

10. Steam generator according to claim 1, wherein said cyclone separator is composed of plastic and in one piece by being assembled from at least two parts which are non-detachably connected to one another.

11. Steam generator according to claim 1, wherein said steam outlet from said cyclone separator is arranged centrally and is formed so as to run upwards.

12. Steam generator according to claim 1, wherein said cyclone separator has:
a cyclone channel which runs at least in sections in arcuate fashion and which serves for separating water steam into both steam and water,
at least one water steam inlet for an introduction of water steam from said steam-generating means, arranged therebelow, upwards into said cyclone channel or into said cyclone separator,
said steam outlet at an end region of said cyclone channel,
said water outlet from said cyclone separator or from said cyclone channel for a discharge of separated-off water downwards into said steam-generating chamber of said steam-generating means.

13. Steam generator according to claim 12, wherein said cyclone channel has a cross-sectional reduction at a starting region situated close to said water steam inlet.

14. Steam generator according to claim 12, wherein said cyclone channel has a cyclone base, wherein said cyclone base runs, in a radially outer region of said cyclone channel, in a plane, wherein a cyclone side wall narrows in spiral fashion, wherein, in a radially inner region of said cyclone separator, a channel depression is provided which extends below a plane of said cyclone base in a radially outer region of said cyclone channel.

15. Steam generator according to claim 14, wherein a height of said channel depression amounts to more than two times a height of said cyclone channel in said radially outer region.

16. Steam generator according to claim 14, wherein said channel depression is of stepped and/or circular form.

17. Steam generator according to claim 14, wherein said channel depression is at least partially conical or funnel-shaped.

18. Steam generator according to claim 14, wherein said channel depression is radially symmetrical about a central axis of the cyclone separator.

19. Steam generator according to claim 14, wherein said steam outlet is arranged centrally with respect to a centre of said channel depression.

20. Steam generator according to claim 19, wherein said steam outlet has a downwardly projecting steam outlet pipe with a lower pipe opening, said lower pipe opening running in a region of said channel depression and below said plane of said cyclone base in said radially outer region of said cyclone channel.

21. Steam generator according to claim 14, wherein, from a lowest point of said channel depression, said water outlet proceeds downwards.

22. Steam generator according to claim 21, wherein said water outlet ends below a plane in which an upper edge of said heating means of said steam-generating means is situated.

23. Steam generator according to claim 14, wherein said channel depression forms a separation region.

24. Steam generator according to claim 1, wherein, in said cyclone separator, there are provided two separate and spaced-apart water steam inlets for an introduction of water steam from said steam-generating means into said cyclone channel, wherein said two water steam inlets are arranged opposite one another with respect to a central axis of said cyclone separator.

25. Steam cooking appliance having a steam generator according to claim 1 and a cooking chamber, wherein a water inlet into said steam-generating means is provided, and steam from said steam outlet of said cyclone separator is conducted into said cooking chamber.

26. Method for generating steam by means of a steam generator according to claim 1 in a steam cooking appliance for operation of said steam cooking appliance, said method having the steps:
heating water in order to generate water steam,
transferring said water steam directly above said heated water into a cyclone separator, separating off water from said water steam within said cyclone separator by conducting said water steam in an encircling and spirally inwardly narrowing manner,
recirculating said separated-off water into said steam-generating means, and discharging said steam from said cyclone separator into a cooking chamber of said steam cooking appliance.
